(19) United States
(12) Patent Application Publication
(10) Pub. No.: US 2013/0242764 A1
(43) Pub. Date: Sep. 19, 2013

(54) METHOD AND APPARATUS FOR PROVIDING FEEDBACK IN MULTIPOINT TRANSMISSIONS

(71) Applicants: Helka-Liina MÄÄTTÄNEN, Helsinki (FI); Mihai ENESCU, Espoo (FI); Tommi KOIVISTO, Espoo (FI)

(72) Inventors: Helka-Liina MÄÄTTÄNEN, Helsinki (FI); Mihai ENESCU, Espoo (FI); Tommi KOIVISTO, Espoo (FI)

(73) Assignee: RENESAS MOBILE CORPORATION, TOKYO (JP)

(21) Appl. No.: 13/426,080

(22) Filed: Mar. 21, 2012

(30) Foreign Application Priority Data
Mar. 19, 2012 (GB) 1204796.5

(51) Int. Cl. H04W 24/10

(52) U.S. Cl. 370/252

(57) ABSTRACT

An apparatus and a method are provided, which, for example in a user equipment, measure a transmission channel based on reference resources with respect to at least two transmission points, establish a feedback report based on the measurement, the feedback report including a plurality of channel feedback information related to each transmission point, and send the feedback report on a physical uplink control channel.

### CROSS REFERENCE TO RELATED APPLICATION

This application claims benefit under 35 U.S.C. §119(a) and 37 CFR 1.55 to British patent application no. 1204796.5, filed on Mar. 19, 2012, the entire disclosure of which is hereby incorporated by reference.

### TECHNICAL FIELD

The present invention relates to methods, devices and computer program products for providing feedback in multipoint transmissions such as Coordinated Multipoint (CoMP) schemes.

### BACKGROUND

The following meanings for the abbreviations used in this specification apply:
CB Coordinated Beamforming
CoMP Coordinated Multipoint
CRS Common Reference Signal
CS Coordinated Switching
CSI Channel State Information
CQI Channel Quality Indicator
DL Downlink
DPS Dynamic Point Selection
eNB Enhanced Node B
JT Joint Transmission
LTE Long Term Evolution
LTE-A Long Term Evolution Advanced
MIMO Multiple-Input Multiple-Output
MU Multi User
PMI Precoding Matrix Information
PUCCH Primary Uplink Control Channel
RRC Radio Resource Control
RRH Remote Radio Head
UE User Equipment
UL Uplink
WI Work Item

Some embodiments of the present invention relate to 3rd Generation Partnership Project (3GPP) Long Term Evolution (LTE) and LTE-Advanced (LTE-A).

In LTE and LTE-A, single cell single-user (SU-) and multiuser (MU-) multiple-input multiple-output (MIMO) network performance is interference-limited, especially at the cell edge. Therefore, introduction of the coordinated multipoint (CoMP) transmission/reception technology has been considered, where in downlink, multiple points co-operate in scheduling and transmission in order to strengthen desired signals and mitigate inter-cell interference. According to the 3GPP technical report on CoMP, TR36.819, a point is a set of geographically co-located transmit antennas and the sectors of the same site correspond to different points. It should be noted that a cell is formed by one or multiple points.

In joint transmission (JT) CoMP two or more points transmit simultaneously to a CoMP user. Dynamic point selection (DPS) refers to a scheme where the transmission point is switched according to changes in signal strength. In coordinated beamforming/scheduling (CB/CS) the scheduling decisions of neighbor points are coordinated in order to reduce interference. In principle all schemes may include blanking/muting which means that one or more transmission points are blanked/muted to decrease the interference.

The agreed CoMP WI targets specification of intra- and inter-cell DL CoMP schemes operating in homogeneous and heterogeneous configurations. Four main scenarios have been studied so far: intra-site (scenario 1), inter-site with high power RRH (scenario 2), low power RRH within the coverage of the macro cell, without and with the same cell ID (scenarios 3 and 4, respectively). CoMP WI addresses both FDD and TDD, hence unified solutions should be targeted, as it is always the case in LTE specifications.

CoMP schemes utilize multiple points, transmitting the useful signal from either one of the points by coordinating this transmission to the best point, or from multiple points, by joint transmission. Some examples of the current CoMP solutions incur a large amount of feedback which needs to be sent over uplink (UL). On the other hand, the CoMP UE is a cell edge UE, hence there might be very poor signal conditions also for UL.

In order to sustain CoMP schemes, UL feedback is necessary.

In the following some prior art documents are shortly discussed. In R1-120784 Ericsson is proposing to have 2 cooperating points for CoMP transmission. Detailed proposals enabling efficient signaling of CSI feedback in support of CoMP have not been presented. The main RANI discussion is still of the CSI feedback components and their utilization. With respect to Rel-10, the joint coding of RI and PMI1 is performed in PUCCH sub-mode 1-1-1 and can be regarded as one prior art solution. Some discussions can be found in R1-113731 from CATT where high level details regarding UL CSI feedback can be found. Also, two contributions submitted to RAN1#68 discuss PUCCH. First is essentially a resubmission of the above CATT paper, R1-120098 below, and the other one is R1-120463 from TI.

However, the prior art does not give solutions to the problem discussed above in connection with the feedback over uplink in case of a CoMP scheme.

### SUMMARY

The present invention addresses such situation and deals in exemplary embodiments, with improving of feedback over uplink in case of a CoMP scheme.

Various aspects of examples of the invention are set out in the claims.

According to a first exemplary embodiment, there is provided an apparatus comprising a processing system, which may be embodied as at least one processor and at least one memory including computer program code. The processing system is arranged to cause the apparatus to measure a transmission channel based on reference resources with respect to at least two transmission points, establish a feedback report based on the measurement, the feedback report including a plurality of channel feedback information related to each transmission point, and send the feedback report on a physical uplink control channel.

The apparatus according to the first aspect may be a user equipment or a part thereof.

According to a second exemplary embodiment, there is provided an apparatus comprising a processing system, which may be embodied as at least one processor and at least one memory including computer program code. The processing system is arranged to cause the apparatus to receive a feedback report on a physical uplink control channel, the feedback report including a plurality of channel feedback information related to at least two transmission points measured by a user equipment, and perform scheduling of a multipoint transmission of the user equipment based on the feedback report.

The apparatus according to the second aspect may be a base station such as an eNB equipment or a part thereof.

According to a third exemplary embodiment, there is provided a method comprising measuring a transmission channel based on reference resources with respect to at least two transmission points; establishing a feedback report based on the measurement, the feedback report including a plurality of channel feedback information related to each transmission point; and sending the feedback report on a physical uplink control channel.

According to a fourth exemplary embodiment, there is provided a method comprising receiving a feedback report on a physical uplink control channel, the feedback report including a plurality of channel feedback information related to at least two transmission points measured by a user equipment, and performing scheduling of a multipoint transmission of the user equipment points based on the feedback report.

Advantageous developments are defined in the dependent claims.

Thus, according to embodiments of the present invention, a simplified report over a PUCCH is achieved, so that feedback is simplified and, hence, improved.

### BRIEF DESCRIPTION OF THE DRAWINGS

For a more complete understanding of some example embodiments of the present invention, reference is now made to the following descriptions taken in connection with the accompanying drawings in which:

FIG. 1 schematically illustrates a UE according to an example embodiment of the present invention,

FIG. 2 shows a flow chart illustrating a basic operation carried out by a UE according to an example embodiment of the present invention,

FIG. 3 schematically illustrates an eNB according to an example embodiment of the present invention, and

FIG. 4 shows a flow chart illustrating a basic operation carried out by an eNB according to an example embodiment of the present invention.

### DETAILED DESCRIPTION

Exemplary aspects of the invention will be described herein below. It is to be noted that the following exemplary description refers to an environment of the LTE system (long term evolution) and/or local area networks thereof. However, it is to be understood that this serves for explanatory purposes only. Other systems differing from the LTE system can be adopted.

However, before describing embodiments of the invention in detail, the problem underlying the present invention is further described in the following.

CoMP is intended to improve the performance of cell edge users, as especially at the cell edge, performance is interference limited. CoMP measurement set is formed by M cells/points for which the UE is measuring channel state information. The cooperation/reporting set has been limited to N cells/points defining the number of points involved in the actual CoMP scheme for which CSI feedback is reported. The common assumption has been that the CoMP reporting set is formed by two to three points, while the number of points actually involved in the CoMP scheme does not need to be mentioned in specifications but is left for network implementation. The point from which the UE would receive transmission in single-point mode is defined as the serving point. Hence the UE will be measuring M cells/points, or more generally M CSI-RS resources (see below for definition). From this the UE reports CSI feedback for N CSI-RS resources where it may be likely that N=M.

In Release 10 different reference signals (RS) were defined for CSI estimation and data demodulation purposes. Namely, channel state information reference symbols (CSI-RS) and demodulation reference symbols (DM-RS). PDSCH resource element muting is also specified (known as zero-power CSI-RS in the specifications), this allowing for multi-cell channel estimation due to reducing interference in channel estimation. In Release 11 it has been agreed that the UE may receive multiple CSI-RS configurations. Typically the eNB would configure the UE to measure multiple CSI-RS configurations such that one CSI-RS configuration corresponds to transmission from one point, i.e. the reference signals transmitted within the resources given by one CSI-RS configuration are all transmitted from the same geographical location (point). Hence, the CSI feedback measured from one CSI-RS resource typically corresponds to CSI feedback for one point.

The baseline feedback has been agreed to be implicit feedback which comprises, for example, the following:

Rank report (RI), which indicates the recommended number of spatially multiplexed transmission layers.

Precoding matrix indicator (PMI), which indicates the recommended precoder index in a pre-determined codebook. Each precoder indicates the antenna weights to be applied at the transmit antennas for optimum performance.

Channel quality indicator (CQI), which indicates the modulation and coding scheme to be applied, hence enabling for link adaptation at the eNB side.

Hence, typically the UE estimates the channel, selects rank and PMI and calculates the post-processing (after receiver) SINR and derives the CQI based thereon. CQI may be seen as indicative of the post processing SINR. Release 10 feedback operates per point, i.e. the UE only provides RI/PMI/CQI feedback for one point. In Release 11, the CoMP specific flavors are that a UE may receive CSI-RS resources for more than one point and it is possible to design aggregated (over multiple CSI-RS resource) or per point (per CSI-RS resource) feedback. The per-point PMIs may be improved by a combiner (inter-CSI-RS resource) feedback that may be an inter-point phase, an inter-point amplitude value and/or a point selection indicator. Table 1 summarizes the feedback and channel estimation options for each CoMP scheme.

TABLE 1
Feedback for different CoMP schemes

| | | DPS + | |
|---|---|---|---|
| | JT | muting | CS/CB + muting |
| Feedback | 1) Per CSI-RS resource | Per CSI-RS | Per CSI-RS |
| | PMI/CQI (+ inter-CSI- | resource | resource PMI/CQI |
| | RS resource feedback) | PMI/CQI + | or CS/CB + muting |
| | 2) Per CSI-RS resource | point | specific additional |
| | PMI (+inter-CSI-RS | selection | feedback |
| | resource feedback) + | indication + | |
| | aggregated CQI + | possible | |
| | serving point CQI | muting | |
| | 3) Aggregated | indication | |
| | PMI/CQI + serving | | |
| | point PMI/CQI | | |
| Channel | Per point CSI-RS or | Per point | Serving point CSI- |
| estimation | aggregated single CSI- | CSI-RS | RS + possibly other |
| | RS pattern | | point CSI-RS |

On the uplink, there are two ways of CSI feedback reporting: the first way is aperiodic reporting on the physical uplink shared channel (PUSCH), in which case the eNB may at any time trigger the UE to report CSI feedback using a separate CQI trigger included in the uplink scheduling grant. Note that periodic PUSCH might be designed in Rel 11.

The second way of CSI feedback reporting is periodic reporting on physical uplink control channel (PUCCH), in which case the UE is configured with periodic reporting instants and is hence continuously reporting CSI feedback. Typically PUCCH is low rate wideband feedback, e.g. in Release 8 to 10 the maximum number of feedback payload bits is 11, while more rich (e.g. frequency selective) and hence higher rate CSI feedback can be included on PUSCH with even hundreds of payload bits. PUCCH reporting is a key coverage enabler, as for example in the feedback mode 1-1, the eNB can make use of wideband PMI and wideband CQI for scheduling the cell edge users. Such simple feedback modes such as 1-1 are also easily verifiable and of significant importance for any network vendors and operators.

In LTE Rel-8 the channel state information (CSI) feedback consists of the three distinct components RI, PMI and CQI as described above. In the LTE Rel-8 PUCCH feedback schemes the CQIs and the PMIs feedback are jointly encoded while the RI is encoded separately. This is due to the fact that the value of RI determines the payload of the rest of the CSI. The RI is transmitted in a separate report as the PMI and the CQI, while the periodicity of the RI report is lower compared to the periodicity of the PMI and CQI report.

In LTE Rel-10 the channel state information feedback consists of the same quantities as in LTE Rel-8 (that is CQI, RI), while for eight transmit antennas the PMI is constructed from two precoding indexes PMI1 and PMI2. The PMI1 and PMI2 correspond to the precoding codebooks W1 and W2. The PMI1 is jointly encoded with the RI and transmitted in a first report. The PMI2 is transmitted with the CQI in a second report. The periodicity of the first report is lower than the periodicity of the second report.

In LTE Rel-11 during the RAN1#66bis (10-14 Oct. 2011) and RAN1#67 (14-18 Nov. 2011) the following points were agreed:
“Definition: “CSI-RS resource” here refers to a combination of “resourceConfig” and “subframeConfig” which are configured by higher layers.
Working assumption from RAN1#66bis:
   Standardise a common feedback/signalling framework suitable for scenarios 1-4 that can support CoMP JT, DPS and CS/CB.
   Feedback scheme to be composed from one or more of the following, including at least one of the first 3 sub-bullets:
      feedback aggregated across multiple CSI-RS resources per-CSI-RS-resource feedback with inter-CSI-RS-resource feedback per-CSI-RS-resource feedback per cell Rel-8 CRS-based feedback
Note that use of SRS may be taken into account when reaching further agreements on the above.
Agreement from RAN1#67:
   CSI feedback for CoMP uses at least per-CSI-RS-resource feedback.”

In LTE Rel-11 the CSI Feedback may Comprise Following:
Per CSI-RS resource (per point) feedback:
   CQI
   PMI
   RI
Inter-CSI-RS resource feedback (feedback over multiple points)

As seen in Table 1, there are many feedback options for CoMP support under discussion and the views in 3GPP differ.

As mentioned above, the embodiments deal with sending of feedback for CoMP schemes. According to the prior art, the feedback is sent on both PUCCH and PUSCH channel. However, it is the PUCCH which is more robust in terms of coverage. Thus, having a simple CoMP scheme, with feedback self-contained in a single PUCCH report, can be a key for system operation and quite an appealing candidate for the operators and network vendors.

Embodiments of the present invention provide the simplest possible feedback support for a simple CoMP scheme, supported by PUCCH only channel. In addition, the reception of a single PUCCH report should enable eNB transmit to the UE in CoMP mode. Embodiments of the invention described below deal with UL signaling of such CSI feedback.

In particular, according to certain embodiments of the present invention, a PUCCH container (CoMP PUCCH) is designed that would enable a simple CoMP operation for two cooperating points. If PUCCH container size permits, it might be possible to accommodate feedback from more than two cooperating points.

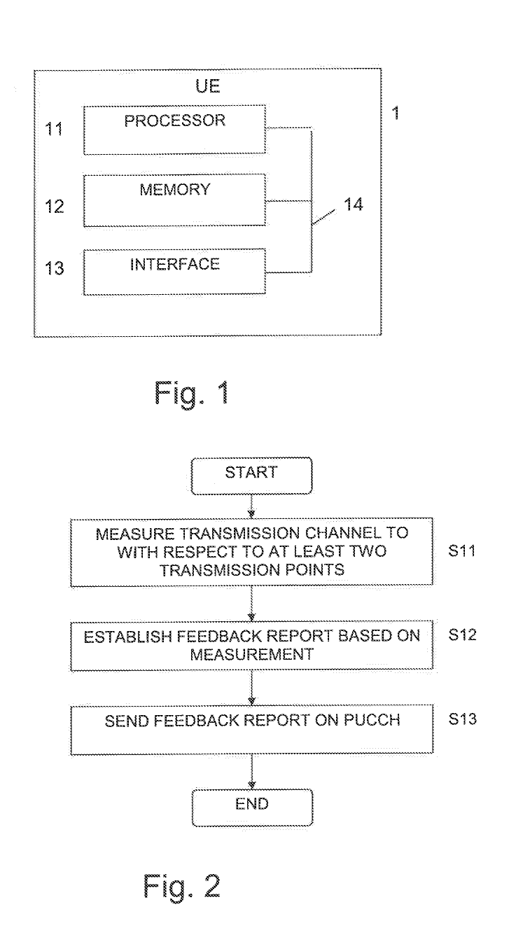

In the following, a basic idea of certain embodiments of the present invention is described by referring to FIGS. 1 to 4

FIG. 1 illustrates a simplified block diagram of a user equipment (UE) 1 according to an embodiment of the present invention. It is noted that the UE, and the corresponding apparatus according to the embodiment may consist only of parts of the UE, so that the apparatus may be installed in an UE, for example. Moreover, also the UE is only an example and may be replaced by another suitable network element.

The UE 1 according to this embodiment comprises a processor 11 and a memory 12. The memory comprises a computer program, wherein the memory 12 and the computer program are configured to, with the processor, cause the apparatus to measure a transmission channel based on reference resources with respect to at least two transmission points, establish a report based on the measurement, the report including a plurality of channel feedback information related to each transmission point, and send the report on a physical uplink control channel.

Optionally, the UE 1 may also comprise an interface 13 for providing connections to other network elements. Moreover, the processor 11, the memory 12 and the interface 13 may be inter-connected by a suitable connection 14, e.g., a bus or the like. Moreover, it is noted that the apparatus may comprise more than one processor, more than one memory and/or more than one interface, if this is suitable for a particular structure.

A basic operation as carried out, for example, by the UE 1 shown in FIG. 1 is shown in the flowchart in FIG. 2. In step S11, a transmission channel is measured based on reference resources with respect to at least two transmission points. In step S12, a feedback report is established based on the measurement, wherein the feedback report includes a plurality of channel feedback information related to each transmission point. In step S13, the feedback report is sent on a physical uplink control channel.

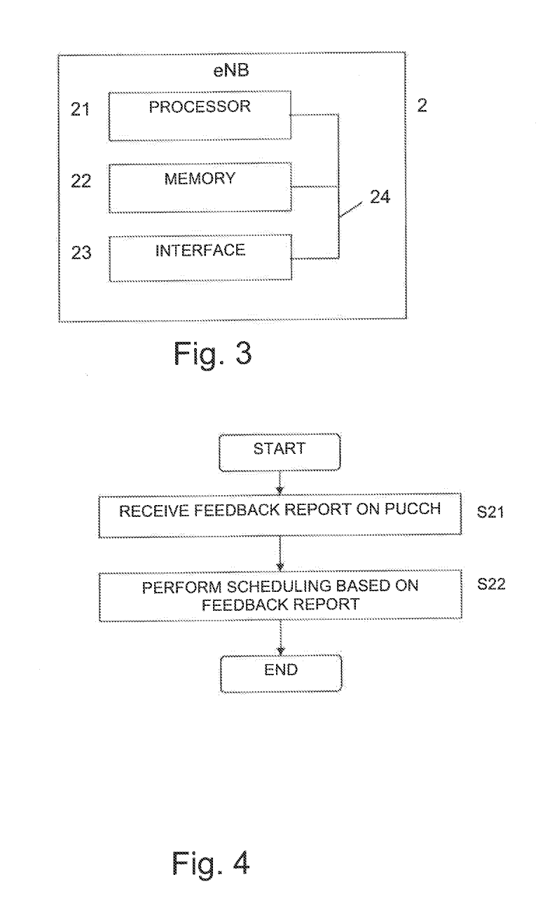

FIG. 3 shows an eNB 2 as an example for an apparatus which carries out the CoMP configuration. It is noted that the eNB, and the corresponding apparatus according to the embodiment may consist only of parts of the eNB, so that the apparatus may be installed in an eNB, for example. Moreover, also the eNB is only an example and may be replaced by another suitable network element.

The eNB 2 according to this embodiment comprises a processor 21 and a memory 22. The memory comprises a computer program, wherein the memory 22 and the computer program are configured to, with the processor, cause the apparatus to receive a report on a physical uplink control channel, wherein the feedback report includes plurality of channel feedback information related to at least two transmission points measured by a user equipment, and perform of a multipoint transmission of the user equipment scheduling based on the report.

Optionally, similar as in case of the UE 1 shown in FIG. 1, the eNB 2 may also comprise an interface 23 for providing connections to other network elements. Moreover, the processor 21, the memory 22 and the interface 23 may be inter-connected by a suitable connection 24, e.g., a bus or the like. Moreover, it is noted that the apparatus may comprise more than one processor, more than one memory and/or more than one interface, if this is suitable for a particular structure.

The flowchart of FIG. 4 shows an example for a basic operation as carried out, for example, by the eNB 2 shown in FIG. 3. In step S21, a feedback report is received on a physical uplink control channel, the feedback report including plurality of channel feedback information related to at least two transmission points measured by a user equipment. In step S22, scheduling of a multipoint transmission of the user equipment is performed based on the feedback report.

One of the two transmission points described above may be the eNB 2. Furthermore, it is noted that scheduling of the multipoint transmission (e.g., CoMP transmission) can be performed based on the received feedback report. That is, the feedback report is self-contained and comprises the necessary channel feedback information for performing scheduling.

Hence, according to some embodiments of the present invention, the feedback report, which contains different channel feedback information (e.g., CSI) related to the configured CSI-RS transmission points as measured by the user equipment is sent via the physical uplink control channel (e.g., PUCCH). In this way, a simple feedback for a simple CoMP scheme can be achieved.

The channel feedback information may comprise precoding matrix information (e.g., PMI) and channel quality information (e.g., CQI).

In the following, some more detailed embodiments of the present invention are described.

In particular, these embodiments are described based on the assumption that a simple CoMP scheme is applied. Such a simple CoMP would assume rank 1, which is a good assumption for the cell edge users. Simple CoMP would also involve cooperation of two points, hence two PMIs are needed. That is, in current PUCCH design, 11 bits are provided, so that CSI feedback reports of two transmission points can be accommodated. However, the PUCCH design could be changed, so that, for example the following two cases could be considered:

1. The PUCCH size can increase from 11 bits to xx bits and this can enable feedback from more than two points.

2. More than two PMIs and two CQIs can be accommodated in one PUCCH, for example in case of an increased size PUCCH, it might be possible to accommodate for example 2 PMIs and 3 or 4 CQIs.

However, depending on the design of the PUCCH, for example in case PUCCH will be re-designed already in Rel 11 in more than 11 bits and hence rank 2 might be accommodated, then also three points feedback might be accommodated while also two points but with more than two CSIs might be accommodated.

It is noted that the feedback is self contained within a single PUCCH and the eNB can utilize that for CoMP transmission without waiting for another PUCCH report. One other characteristic is that this feedback is always wideband.

In the following, the case of a two point CoMP transmission is considered. The inter CSI-RS resource feedback, which would be a phase combiner, is there for coherent JT transmission. Thus two PMIs without a combiner enable CS/CB, DPS and non-coherent JT. Also two CQIs are needed. The CQI options are per point CQIs, CQI1 and CQI2, and an aggregated CQI for JT. The relation between these CQIs is roughly CQlaggr=CQI1+CQI2. Thus, it is enough to have any two of these CQIs and the third CQI may be derived. One of the two CQIs may be defined as relative CQI of the other, thus one 4 bit CQI and one 3 bit CQI.

For a PUCCH with more than 11 bits, as mentioned above, the case of two per point CQI can be applied, while also two CQIs with muting assumption for the two points (these could be delta CQIs from the two per point CQIs), hence 4 CQIs.

According to certain embodiments, a CSI feedback signaling framework to support a simple CoMP operation while also maximizing implementation synergy with existing LTE releases is defined.

More specifically, it is proposed to have a CoMP PUCCH report, where the two PMIs and two of these CQIs may be reported wideband. Rank is assumed to be 1, thus instead of signaling the rank, the PUCCH may contain an indication that this specific PUCCH report is a CoMP PUCCH report, which indicates that it contains CoMP feedback. That is, instead of signaling the rank, there may be an indication that the PUCCH is now a CoMP PUCCH and which of the two CQIs are included therein. i.e. solutions 2 and 3 in the table below.

The following table 2 indicates a mapping of the channel state information signaling fields from LTE Rel-8/10/11 according to some embodiments of the present invention. In particular, the two columns on the right indicate the specific mappings according to the embodiments, wherein three different solutions are indicated, which are described in more detail in the following. The second column from the right indicates the case of PUCCH using 11 bits, whereas the first column from the right indicates the case in which an enhanced PUCCH comprises more than 11 bits is available.

TABLE 2

| | | | | | LTE Rel-11 |
|---|---|---|---|---|---|
| | | | | | (based on |
| | | | | LTE Rel-11 | enhanced |
| | LTE | LTE Rel-10 | | (based on 11 bit | PUCCH, >11 |
| | Rel-8 | 1-1-1 | 1-1-2 | PUCCH) | bits) |
| Report 1 | RI | RI + | RI | Solution 1: RI + | Solution 1: |
| (2-5 bits) | | PMI 1 | | PMIother | RI + |
| Low | | | | Solution 2: CoMP | PMIother |
| periodicity | | | | indication + | |
| | | | | PMIother | |
| | | | | Solution 3: CoMP | |
| | | | | hyphothesis | |
| | | | | for the | |
| | | | | CQIdelta + | |
| | | | | PMIother | |
| Report 2 | PMI | PMI 2 | PMI1 + | PMIserving cell | PMIserving |
| (11 bits) | | | PMI2 | | cell |
| | CQI | CQI | CQI | CQI + CQIdelta | Solution 1: |
| | | | | | CQI1 + |
| | | | | | CQI1delta (as |
| | | | | | muted CQI) + |
| | | | | | CQI2 + |
| | | | | | CQI2delta (as |
| | | | | | muted CQI) |

One design characteristic of the current PUCCH is that the first report may be configured with lower periodicity compared with the second report. Hence, in this kind of reporting is that one PMI (or whatever feedback component is mapped in the first report) is reported with lower periodicity than the other PMI, and it is proposed to have the serving cell PMI in the second report. Of course it is possible to have it the other way around as well.

As both PMIs are wideband, they can be seen as long term information and hence different reporting periodicities would not significantly influence the performance. All these feedback reports are wideband, thus the aim is to target the most simple CoMP operation support.

Initial evaluations show that a simple CoMP scheme based on rank 1 feedback for the CoMP users and wideband PMIs and CQIs offers performance gains, although with more rich feedback higher gains may be possible.

In the following, a more detailed description of a technical implementation of certain embodiments is given.

First, the signaling on PUCCH is described.

According to embodiments of the present invention, the existing signaling is reused by defining a re-mapping of the components of the first PUCCH report. In legacy releases the RI is transmitted in different subframes than CQI and PMI and with possibly different periodicity, while all the fields are transmitted using PUCCH formats 2/2a/2b. The following new principles are defined for transmission of Release 11 CoMP information:

In particular, PUCCH formats 2/2a/2b, while also new PUCCH formats, may be used for the proposed simple CoMP reporting.

In the following, some specific embodiments are described by referring to table 2. It is noted that in the examples of table 2, also the relative definition of the two CQIs is applied. As mentioned above, one of the two CQIs may be defined as relative CQI to the other. That is, for example, the CQI of the serving cell is referred to as CQI1, and the CQI of the other cell is referred to as CQI2. Then, the CQI mentioned in table 2 can be that of the serving cell, i.e., CQI1, and “CQIdelta” in table 2 is the difference of the CQI of the other cell to that of the serving cell, i.e., CQIdelta=CQI1−CQI2. However, other combinations are possible, as indicated above.

According to a first specific embodiment, as indicated by “Solution 1” in table 2, there are RI and PMI for one of the points in report 1 and PMI of the other point and the two CQIs in report 2. In particular, the PMI of the serving cell is indicated as “PMIserving cell” in table 2 (sent in report 2, indicated in the last two rows of the right column in table 2), and the PMI of the other cell is indicated as “PMIother” in table 2.

According to another embodiment, as indicated by “Solution 2” in table 2, there are an indication of CoMP PUCCH report and PMI for one of the points in Report 1 and PMI of the other point and the two CQIs in Report 2.

According to a further embodiment, as indicated by “Solution 3” in table 2, report 1 the PMI for the other cell (PMIother) and a CoMP hypothesis for delta CQI. In this case the report 2 contains only the PMI of the serving cell and the CQI, but not the CQIdelta.

The CoMP hypothesis for delta CQI means that there are two CQIs, namely the serving cell per point CQI and the other CQI, which may be the other point CQI, or aggregated CQI, or any CQI derived under a CoMP transmission hypothesis. This other CQI is the one send as deltaCQI, wherein it can also be the other way round.

Other mappings of the feedback in reports 1 and 2 are also possible. One rule which could be followed is that the feedback contained in such a CoMP PUCCH report is self contained, that is, the CoMP PUCCH report consisting of the reports 1 and 2 contains the CQIs and PMIs for the transmission points. In this way, the eNB can have a CoMP transmission to one UE based on such reported feedback, without any other feedback aid.

Moreover, according to a further alternative, the PUCCH reports can be multiplexed in time.

Furthermore, a UE may be configured to a CoMP mode by network or the CoMP PUCCH feedback is UE initiated, thus works without a CoMP mode configuration.

In the following, eNB procedures in the technical implementation of certain embodiments of the present invention are described, which may be carried out by the eNB 2 shown in FIG. 3, for example. The eNB signals the UE the CSI-RS resources for which CoMP feedback is to be measured. This is used as an implicit indication to report CoMP feedback in CoMP PUCCH mode.

The eNB uses the report as follows:

In detail, the eNB receives periodic CoMP-PUCCH report. The eNB performs scheduling based on the CoMP-PUCCH report, for example uses the transmission scheme/rank/layer ordering as indicated by the report.

Alternatively, the eNB requests the UE further CoMP feedback which may be transmitted over CoMP-PUCCH and/or PUSCH.

Further alternatively the eNB may utilized multiple CoMP-PUCCH reports to enable specific CoMP schemes.

In the following, UE procedures in the technical implementation of certain embodiments of the present invention are described, which may be carried out by the UE as shown in FIG. 1, for example.

The UE CSI feedback measurement and reporting would work as follows:

The UE first measures the channel corresponding to multiple points based on configured CSI-RS resources.

The UE calculates the full CSI report for serving point including CQI and PMI under rank 1 assumption, and the UE calculates the full CSI report for the other point including CQI and PMI under rank 1 assumption.

The UE then transmits the resulting report in uplink periodic CoMP-PUCCH report based on report formats illustrated in table 2.

In this connection, it is noted that the CoMP PUCCH report replaces the traditional PUCCH report.

Thus, according to embodiments described above, simple feedback support for a simple CoMP scheme is achieved, which is provided only via PUCCH.

It is noted that the invention is not limited to the specific embodiments as described above.

For example, in the embodiments, basically a case of CoMP involving two transmission points is described. However, the invention is not limited to this, and the embodiments may be applied to more than two transmission points. As mentioned above, this could be achieved in case of a re-design of PUCCH such that more than 11 bits would be available, for example.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

According to some aspects of embodiments of the present invention, an apparatus and a method are provided, which, for example in a user equipment, measure a transmission channel based on reference resources with respect to at least two transmission points, establish a feedback report based on the measurement, the feedback report including a plurality of channel feedback information related to each transmission point, and send the feedback report on a physical uplink control channel.

According to a further aspect of embodiments of the present invention, an apparatus is provided which comprises means for measuring a transmission channel based on reference resources with respect to at least two transmission points; means for establishing a feedback report based on the measurement, the feedback report including a plurality of channel feedback information related to each transmission point; and means for sending the feedback report on a physical uplink control channel.

According to a further aspect of embodiments of the present invention, an apparatus is provided which comprises means for receiving a feedback report on a physical uplink control channel, the feedback report including plurality of channel feedback information related to at least two transmission points measured by a user equipment; and means for performing scheduling of a multipoint transmission of the user equipment based on the feedback report.

It is to be understood that any of the above modifications can be applied singly or in combination to the respective aspects and/or embodiments to which they refer, unless they are explicitly stated as excluding alternatives.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-31. (canceled)

32. An apparatus comprising
at least one processor and
at least one memory including computer program code,
the at least one memory and the computer program being configured to, with the at least one processor, cause the apparatus to
measure a transmission channel based on reference resources with respect to at least two transmission points,
establish a feedback report based on the measurement, the feedback report including a plurality of channel feedback information related to each transmission point, and
send the feedback report on a physical uplink control channel.

33. The apparatus according to claim 32, wherein
the report consists of a first report and a second report which may be sent with different periodicities, and
the at least one memory and the computer program are configured to, with the at least one processor, cause the apparatus to
distribute the plurality of channel feedback information on the first report and the second report.

34. The apparatus according to claim 32, wherein
the feedback report comprises
channel quality information for each of the transmission points, and
precoding matrix information for each of the transmission points, and/or
rank information, and/or
wherein the report is wideband.

35. The apparatus according to claim 34, wherein
the transmission points consist of a first transmission point and at least one second transmission point, and the first report has a smaller periodicity than the second report, and
wherein the at least one memory and the computer program are configured to, with the at least one processor, cause the apparatus to
insert the precoding matrix information for the second transmission point in the first report, and to insert the precoding matrix information for the first transmission points in the second report,
wherein the first transmission point is a fallback transmission point.

36. The apparatus according to claim 35, wherein the at least one memory and the computer program are configured to, with the at least one processor, cause the apparatus to
insert the channel quality information of the first transmission point and the at least one second transmission point in the second report, or,
in case there are more than two channel quality information items, to insert at least two channel quality information items in the second report.

37. The apparatus according to claim 35, wherein
the rank information comprises a rank indicator or an indication that the report sent on the physical uplink control channel is a collaborative multipoint transmission report, and
the at least one memory and the computer program are configured to, with the at least one processor, cause the apparatus to
insert the rank information into the first report.

38. The apparatus according to claim 35, wherein the first transmission point is a serving cell of the apparatus.

39. The apparatus according to claim 32, wherein the at least one memory and the computer program are configured to, with the at least one processor, cause the apparatus to
receive an instruction from a network control node to perform the measurements, or to initiate the measurements by itself.

40. The apparatus according to claim 33, wherein the at least one memory and the computer program are configured to, with the at least one processor, cause the apparatus to
report the channel quality information by defining one of the channel quality information relative to the other.

41. An apparatus comprising
at least one processor and
at least one memory including computer program code,
the at least one memory and the computer program being configured to, with the at least one processor, cause the apparatus to
receive a feedback report on a physical uplink control channel, the feedback report including a plurality of channel feedback information related to at least two transmission points measured by a user equipment, and
perform scheduling of a multipoint transmission of the user equipment based on the feedback report.

42. The apparatus according to claim 41, wherein
the feedback report consists of a first report and a second report which may be sent with different periodicities, wherein the plurality of channel feedback information are distributed on the first report and the second report.

43. The apparatus according to claim 41, wherein
the feedback report comprises
channel quality information for each of the transmission points, and
precoding matrix information for each of the transmission points, and/or
rank information, and/or
the feedback report is wideband,

44. The apparatus according to claim 43, wherein
the rank information comprises a rank indicator or an indication that the report sent on the physical uplink control channel is a collaborative multipoint transmission report.

45. The apparatus according to claim 41, wherein the at least one memory and the computer program are configured to, with the at least one processor, cause the apparatus to
send an instruction to the user equipment to perform the measurements including information on which resources the measurements are to be performed.

46. The apparatus according to claim 42, wherein two transmission points are present, and the channel quality information are defined such that one of the channel quality information is defined relative to the other.

47. A method comprising
measuring a transmission channel based on reference resources with respect to at least two transmission points,
establishing a feedback report based on the measurement, the feedback report including a plurality of channel feedback information related to each transmission point, and
sending the feedback report on a physical uplink control channel.

48. The method according to claim 47, wherein
the report consists of a first report and a second report which may be sent with different periodicities, the method further comprising
distributing the plurality of channel feedback information on the first report and the second report.

49. The method according to claim 47, wherein
the feedback report comprises
channel quality information for each of the transmission points, and
precoding matrix information for each of the transmission points, and/or
rank information, and/or
wherein the report is wideband.

50. The method according to claim 49, wherein
the transmission points consist of a first transmission point and at least one second transmission point, and the first, report has a smaller periodicity than the second report, the method further comprising
inserting the precoding matrix information for the second transmission point in the first report, and inserting the precoding matrix information for the first transmission point in the second report,
wherein the first transmission point is a fallback transmission point.

51. The method according to claim 49, further comprising
reporting the channel quality information by defining one of the channel quality information relative to the other.
